(19) United States
(12) Patent Application Publication
(10) Pub. No.: US 2009/0107527 A1
(43) Pub. Date: Apr. 30, 2009

(54) METHOD OF CLEANING TRANSPARENT DEVICE IN A THERMAL PROCESS APPARATUS, THERMAL PROCESS APPARATUS AND PROCESS USING THE SAME THERMAL PROCESS APPARATUS

(75) Inventors: Yu-Yung Wang, Hsinchu County (TW); Shin-Long Wu, Kaohsiung County (TW); Chao-Hu Liang, Hsinchu City (TW); Sheng-Yao Lin, Hsinchu County (TW); Hui-Shen Shih, Changhua Hsien (TW); Yu-Fang Chien, Taipei County (TW)

Correspondence Address: J C PATENTS, INC., 4 VENTURE, SUITE 250, IRVINE, CA, 92618, US

(73) Assignee: UNITED MICROELECTRONICS CORP., Hsinchu (TW)

(21) Appl. No.: 11/931,757

(22) Filed: Oct. 31, 2007

(51) Int. Cl. B08B 5/00; B08B 13/00; B08B 7/00

(52) U.S. Cl. 134/18; 134/42; 134/21; 134/115 R; 134/56 R

(57) ABSTRACT

A method of cleaning a transparent device in a thermal process apparatus, wherein the transparent device is disposed in a chamber of a thermal process apparatus, and the transparent device includes a wafer holder for carry a wafer disposed under the transparent device, and an energy source output device disposed above the transparent device in the chamber, is provided. The method of the present invention includes performing a surface treatment step to clean a surface of the transparent device.

### BACKGROUND OF THE INVENTION

1. Field of Invention

The present invention relates to a semiconductor apparatus and a semiconductor process using the apparatus. More particularly, the present invention relates to a method of cleaning a transparent device in a thermal process apparatus, a thermal process and a thermal process apparatus.

2. Description of Related Art

The semiconductor industry is being developed toward the direction of the manufacturing technology of low cost and high integration. Hence, the rapid thermal process (RTP) has been gradually replacing the conventional heat treatment step conducted in high temperature furnace. The importance of the rapid thermal process in the future integrated circuit processing is undeniable. Further, the technology of rapid thermal process has been applied in many semiconductor processes in the field of research and commercially.

In general, the equipments for the RTP mainly include a wafer holder for carrying a wafer, a set of lamps configured above the wafer and a quartz window configured between the lamps and the wafer. The material of the quartz window is a transparent material, in which light form the lamps can be evenly irradiated on the wafer to enhance the reliability and the uniformity of the process layer on the wafer.

Normally, performing the semiconductor process using the equipments of the RTP, a coating material may form on a part of the quartz window surface that is near the wafer. The coating material on the surface will cause the light that passes through the quartz window surface to be non-uniform. Hence, the yield of the process is affected. Further, as the coating material the quartz window surface accumulates to a considerable thickness, the flakes of the coating material may peel off to contaminate the wafer. Ultimately, the process yield is lowered and the products may become defective.

Currently, the treatment of the coating material on the quartz window surface is achieved by monitoring the thickness increase of the coating material during each process and replacing the quartz window with a new one as the coating material has accumulated to a certain thickness. This approach not only affects the up-time of the apparatus, the repairing cost and defective products would increase significantly.

### SUMMARY OF THE INVENTION

The present invention is to provide a method of cleaning a transparent device in a thermal process apparatus, a thermal process and a thermal process device, wherein the various problems in the conventional practice are obviated and the uniformity of the light source through the transparent device is enhanced to lower the manufacturing cost and to raise the process yield.

The present invention is to provide a method of cleaning a transparent device in a thermal process apparatus. The transparent device is positioned in a reaction chamber of the apparatus, and the reaction chamber includes at least a wafer holder for holding a wafer, wherein the wafer holder is configured under the transparent device; an energy source output device, disposed above the transparent device. The method of the present invention includes, for example, performing a surface treatment step to clean the surface of the transparent device.

According to a method of cleaning a transparent device in a thermal process apparatus of the present invention, the above surface treatment step removes a coating material on the surface of the transparent device or alters the coating material to become transparent.

According to a method of cleaning a transparent device in a thermal process apparatus of the present invention, the above surface treatment step concurrently cleans the wafer holder.

According to a method of cleaning a transparent device in a thermal process apparatus of the present invention, the above-mentioned treatment step includes a step of delivering a treatment gas, wherein the step of delivering the treatment gas is conducted at a temperature greater than 500° C. and for a period of greater than 5 seconds, for example. If the coating material is an organic material, the treatment gas includes, but not limited to, an oxygen-containing gas or a gas mixture, such as oxygen gas, ozone gas, nitrogen gas, xelogen gas or a combination thereof. If the coating material is a metal material or an inorganic material, the treatment gas includes, but not limited to, a halogen gas or a combination of halogen gases such as, fluorine gas, chlorine gas, bromine gas or a combination thereof.

According to a method of cleaning a transparent device in a thermal process apparatus of the present invention, the above surface treatment step further includes applying an ultra-violet light source, an electron beam, a halogen light source, a laser, microwave, an electromagnetic wave or an electromagnetic field.

According to a method of cleaning a transparent device in a thermal process apparatus of the present invention, the energy source output device includes a device that provides, for example, an ultra-violet light source, a halogen light source, an infrared red light source, a laser, an electron beam, microwave, an electromagnetic wave or an electromagnetic field.

According to a method of cleaning a transparent device in a thermal process apparatus of the present invention, the above thermal process apparatus is a rapid thermal process apparatus.

The present invention further provides a process, in which a thermal process apparatus is applied. The above mentioned reaction chamber of the apparatus includes at least a transparent device, a waver holder for carrying a wafer, wherein the wafer holder is disposed under the transparent device; an energy source output device, disposed above the transparent device. The thermal process of the invention includes, for example, performing a process step on the wafer, followed by performing a surface treatment step on the surface to clean the surface of the transparent device and to concurrently remove a coating material on the surface of the transparent device.

According to the process, in which a thermal process apparatus is applied of an embodiment of the present invention, the above-mentioned surface treatment step includes a step of delivering a treatment gas. The step of the treatment gas is conducted at a temperature greater than 500° C. for a period of greater than 5 seconds, for example. If the coating material is an organic material, the treatment gas includes, but not limited to, oxygen-containing gas or a gas mixture, such as oxygen gas, ozone gas, nitrogen gas, xelogen gas or a combination thereof. If the coating material is a metal material or an inorganic material, the treatment gas includes, but not limited to, a halogen gas or a combination of halogen gases such as, fluorine gas, chlorine gas, bromine gas or a combination thereof.

According to the process, in which a thermal process apparatus is applied of an embodiment of the present invention, the above surface treatment step further includes applying an ultra-violet light source, an electronic beam light source, a halogen light source, an infrared light source, a laser, microwave, an electromagnetic wave or an electromagnetic field.

According to the process, in which a thermal process apparatus is applied of an embodiment of the present invention, the energy source input device includes a device that provides, for example, an ultra-violet light source, a halogen light source, an infrared red light source, a laser, an electromagnetic wave or an electromagnetic field.

According to the process, in which a thermal process apparatus is applied of an embodiment of the present invention, the above-mentioned process includes, for example, a salicide process, and annealing process, a deposition process, a low dielectric (low-K) material treatment process and an ultra-violet curing process. When the above-mentioned process is a salicide process, the wafer may be removed from the reaction chamber subsequent to the manufacturing process and prior to the surface treatment process.

According to the process, in which a thermal process apparatus is applied of an embodiment of the present invention, the apparatus of the above-mentioned thermal process apparatus includes a rapid thermal process apparatus.

The present invention provides a thermal process apparatus, applicable in a semiconductor fabrication process. The thermal process apparatus of the invention includes a transparent device, a wafer holder, an energy source output device and a surface cleaning device. The transparent device is disposed in a reaction chamber of this apparatus. The wafer holder, which is for accommodating a wafer, is disposed under the transparent device. The energy source output device is disposed above the transparent device. Further, the surface treatment device is disposed in the reaction chamber. The surface cleaning device is for cleaning the surface of the transparent device.

According to the thermal process apparatus of an embodiment of the present invention, the above-mentioned surface cleaning device is disposed between the transparent device and the wafer holder, or underneath the wafer holder.

According to the thermal process apparatus of an embodiment of the present invention, the above-mentioned surface cleaning device is for removing a coating material on the surface of the transparent device or altering the coating material to become transparent.

According to the thermal process apparatus of an embodiment of the present invention, the above-mentioned surface cleaning device concurrently cleans the wafer holder.

According to the thermal process apparatus of an embodiment of the present invention, the above-mentioned surface cleaning device includes a device that provides, for example, an ultra-violet light source, an electron beam, a halogen light source, an infrared light source, a laser, microwave, an electromagnetic wave or an electromagnetic field.

According to the thermal process apparatus of an embodiment of the present invention, the above-mentioned energy source output device includes a device that provides, for example, an ultra-violet light source, a halogen light source, an infrared light source, a laser, an electron beam, microwave, an electromagnetic wave or an electromagnetic field.

According to the thermal process apparatus of an embodiment of the present invention, above-mentioned thermal process includes, for example, a salicide process, and annealing process, a deposition process, a low dielectric material (low-K) treatment and an ultra-violet curing process.

According to the thermal process apparatus of an embodiment of the present invention, the above-mentioned thermal process apparatus includes a rapid thermal process apparatus, for example.

According to the thermal process of an embodiment of the present invention, a monitoring device is further provided and is configured inside the reaction chamber to continuously detect the transparency of the transparent device. Moreover, an advance process control (APC) device is included to automatically feedback the detection results to the surface cleaning device.

The apparatus of the invention includes the surface cleaning device for cleaning the coating material on the surface of the transparent device or altering the coating material to become transparent inside the thermal process apparatus. Hence, any effect of the coating material on the transparent device is prevented to improve the process yield. Moreover, the method and the process of the present invention can effectively clean the surface of the transparent device and remove the coating material on the surface of the transparent device. Hence, the process yield is increased to lower the replacement rate of the transparent device and to effectively cost down the production.

In order to make the aforementioned and other objects, features and advantages of the present invention comprehensible, a preferred embodiment accompanied with figures is described in detail below.

### BRIEF DESCRIPTION OF THE DRAWINGS

FIG. 1 is a schematic diagram illustrating a thermal process apparatus according to an embodiment of the present invention.

FIG. 2 is a flow diagram of steps in an exemplary thermal process according to an embodiment of the present invention.

### DESCRIPTION OF EMBODIMENTS

The present invention can be better understood by way of the following embodiments but which are not to be construed as limiting the scope of the invention.

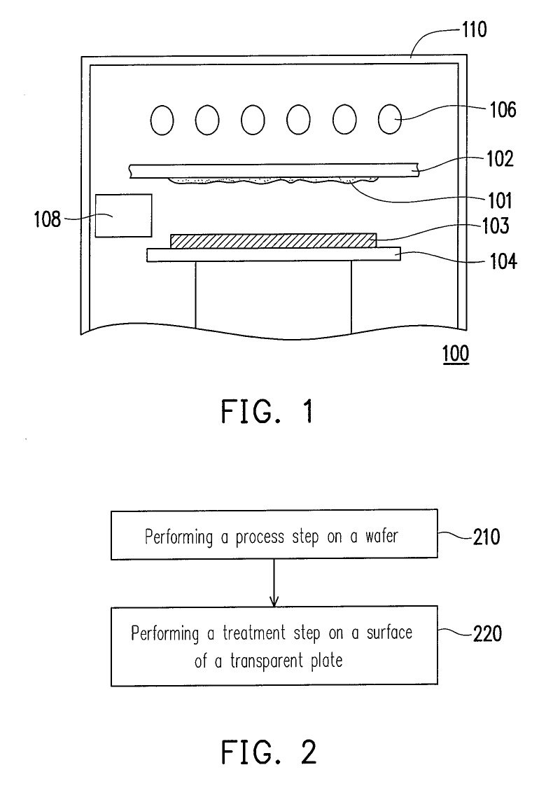

Referring to FIG. 1, FIG. 1 is a schematic diagram illustrating a thermal process apparatus according to an embodiment of the present invention. The thermal process apparatus 100 is applicable for a thermal treatment in typical semiconductor fabrication process. More particularly, the thermal process apparatus 100 is applicable for a rapid thermal processing (RTP). For example, the thermal process apparatus 100 is applicable in a salicide process, a deposition process for forming silicon oxide, silicon nitride and silicon oxynitride, a low dielectric material (low-k) treatment process and a ultra-violet curing process. The thermal process apparatus 100 of the invention is also applicable in performing a series of processes including but not limited to a process of lattice rearrangement and stress-concentration dissipation subsequent to an ion implantation process and silicidation, or an annealing process subsequent to forming borophospho-silicate glass (BPSG) and nitridation.

The thermal process apparatus 100 of an embodiment of the present invention includes a transparent device 102, a wafer holder 104, an energy source output device 106 and a surface cleaning device 108 for the transparent device 102. The transparent device 102 is disposed in a reaction chamber 110. The material of the transparent device 102 includes, for example, quartz or other appropriate transparent material. The wafer holder 104, which is used for accommodating a wafer (for example, wafer 103), is disposed inside the reaction chamber 110 under the transparent device 102. The heating lamps 106 are disposed above the transparent device 102 inside the reaction chamber 110. The light illuminated from the energy source output device 106 passes through the transparent device 102 and evenly delivered to the wafer 103. In general, the energy source output device 106 includes, but not limited to, an ultra-violet light source, a halogen light source, an infrared light source, a laser, an electron beam, microwave, an electromagnetic wave or a electromagnetic field.

It is particularly important to note that the difference between the thermal process apparatus 100 of the present invention and the conventional thermal process apparatus is that the reaction chamber 110 of the thermal process apparatus 100 in this embodiment of the invention further includes a surface cleaning device 108. The surface cleaning device 108 is configured between the transparent device 102 and the wafer holder 104, and its function is for cleaning the surface of the transparent device 102 to remove the coating material on the surface of the transparent device or to alter the coating material to become transparent. In other embodiments, the surface cleaning device 108 can be disposed underneath the wafer holder 104 (not shown) to concurrently clean the wafer holder 104. As a result, not only the process yield is improved, the replacement rate of the transparent device is lowered to effectively cost-down the manufacturing.

The so-called coating material refers to the excessive material (as depicted by the reference number 101 in FIG. 2) formed on the surface of the transparent device 102 due various processing factors during the thermal process. The above coating material 101 includes, for example, an organic material, a metal material or an inorganic material. As the coating material 101 is being generated on the surface of the transparent device, the light illuminated from the energy source output device 106 is unable to deliver the energy source to the wafer uniformly. Hence, the process yield is affected. The architecture of the surface cleaning device and the method of cleaning the surface of the transparent device according to an embodiment of the present invention are disclosed in details hereinafter as follows.

In other embodiments, the thermal process apparatus 100 further includes a real time monitoring device (not shown), for example, a sensor. The real-time monitoring device is configured inside the reaction chamber 110 to continuously detect the transparency of the transparent device 102 in order to appropriately adjust the operational specifications of the surface cleaning device 108 according to the condition of the coating material on the surface of the transparent device 102. Further, the thermal process apparatus 100 may also include an advance process control (APC) apparatus to automatically feedback the detection results to the surface cleaning device 108.

Thereafter, the method and the fabrication process of the present invention are disclosed in details. FIG. 2 is a flow diagram of steps in an exemplary thermal process according to an embodiment of the present invention. The thermal process includes a method of cleaning a transparent device of a thermal process apparatus of the present invention.

Referring simultaneously to FIGS. 1 and 2, a semiconductor process is performed on a wafer 103 (step 210). Step 210 includes, for example, performing a rapid thermal process treatment, such as a salicide process, a deposition process, a low-k material treatment process, an annealing process, an UV curing process. Normally, subsequent to these types of semiconductor processes, a coating material 101 is generated on the surface of the transparent device 102 of the wafer 103. The above coating material 101 includes, for example, an organic material, a metal material or an inorganic. The coating material 101 tends to influence the uniformity of the light source from the energy source output device, being delivered to the wafer 103 to affect the process yield.

Subsequent to the completion of the semiconductor process of the wafer, a surface treatment step (step 220) is performed. In the surface treatment step 220, the surface of the transparent device 102 is cleaned to remove the coating material 101 on the surface of the transparent device 102 or to alter the coating material 101 to become transparent. In one embodiment, the surface treatment step 220 includes a step of delivering a treatment gas. Based on the reaction between the coating material 101 and the treatment gas, the coating material 101 is decomposed, and the transparency of the transparent device 102 is thus unaffected. After the decomposition of the coating material 101, the decomposed coating material is removed via a vacuuming device disposed inside the reaction chamber to prevent the manufacturing of the subsequent wafer being affected. The step of delivering the treatment gas is conducted at a temperature greater than 500° C. for the treatment gas for a period of greater than 5 seconds.

Accordingly, if the coating material 101 is an organic material, the above treatment gas includes, for example, an oxygen-containing gas or a gas mixture such as oxygen gas, ozone gas, nitrogen gas, xelogen gas or a combination thereof. If the coating material 101 is a metal material or an inorganic material, the treatment gas includes, but not limited to, halogen gas or a combination of halogen gases such as, fluorine gas, chlorine gas, bromine gas or a combination thereof.

In one embodiment, prior to the deliverance of the oxygen-containing gas or the gas mixture to perform the surface treatment step, if a process layer above the wafer 103 is metal or other material that may react with the treatment gas, the reaction wafer 103 may be removed from the reaction chamber 110 first to avoid affecting the wafer 103. For example, subsequent to performing a salicide process on the wafer 103 and prior to performing the surface treatment step, the wafer 103 is removed from the reaction chamber 110.

It is important to note that the surface cleaning device 108 of the thermal process apparatus 100 is a component required for the above-mentioned surface treatment step. Moreover, the surface treatment device 108 further includes a device that provides for example, an ultra-violet light source, a halogen light source, an infrared light source, a laser, an electron beam, microwave, an electromagnetic wave or a electromagnetic field. Using a device that provides an ultra-violet light source as an example, the ultra-violet light source enhances the decomposition of the coating material 101 and assists in achieving the required treatment temperature. When a device t provides an electron beam, the electron beam facilitates the decomposition of the coating material.

In other embodiments, it is unnecessary to perform the method of the invention subsequent to the thermal process. The method of cleaning the transparent device of the thermal process apparatus of the invention may be performed during the daily instrument testing step to improve the up-time. Yet, in other embodiments, the cleaning treatment of the transparent device is performed once during a specific time as preventive maintenance (PM) to improve the process yield.

Accordingly, the present invention can effectively clean the surface of the transparent device of the thermal process apparatus or alter a coating material on the surface of the transparent device to become transparent. Not only the adverse effect due the presence of a coating material on the surface of the transparent device in the apparatus is obviated, the process yield is enhanced. Moreover, the present invention is beneficial in lowering the replacement rate of the transparent device to effectively cost-down the fabrication process. On the other hand, the method of the present invention is applicable in the daily testing of the instrument to improve the up-time of the apparatus.

The present invention has been disclosed above in the preferred embodiments, but is not limited to those. It is known to persons skilled in the art that some modifications and innovations may be made without departing from the spirit and scope of the present invention. Therefore, the scope of the present invention should be defined by the following claims.

What is claimed is:

1. A method of cleaning a transparent device of a thermal process apparatus, wherein the transparent device is configured in a reaction chamber of the apparatus, and the reaction chamber comprises at least a wafer holder, which is disposed under the transparent device, for holding a wafer, and an energy source output device disposed above the transparent device, the method comprising:
performing a surface treatment step to clean a surface of the transparent device.

2. The method of claim 1, wherein the surface treatment step removes a coating material on the surface of the transparent device or alters the coating material to become transparent.

3. The method of 1, the surface treatment step concurrently cleans the wafer holder.

4. The method of claim 1, wherein the surface treatment step comprises a step of delivering a treatment gas.

5. The method of claim 4, wherein when the coating material is an organic material, and the treatment gas comprises an oxygen gas, an ozone gas, a nitrogen gas, a xelogen gas or a combination thereof, and when the coating material is a metal material or an inorganic material, the treatment gas comprises a halogen gas or a combination of halogen gases.

6. The method of claim 1, wherein the thermal process apparatus is a rapid thermal process apparatus.

7. A fabrication process, in which a thermal process apparatus is applied, and a reaction chamber of the thermal process apparatus comprising at least a transparent device, a wafer holder for holding a wafer, wherein the wafer holder is disposed under the transparent device, and an energy source output device disposed above the transparent device, the process comprising:
performing a process step on a wafer; and
performing a surface treatment step after the process step to clean a surface of the transparent device and to simultaneously remove a coating material on the surface of the transparent device.

8. The fabrication process of claim 7, wherein the surface treatment step comprises a step of delivering a treatment gas.

9. The fabrication process of claim 8, wherein when the coating material is an organic material, and the treatment gas comprises an oxygen gas, an ozone gas, a nitrogen gas, a xelogen gas or a combination thereof, and when the coating material is a metal material or an inorganic material, the treatment gas comprises a halogen gas or a combination thereof.

10. The fabrication process of claim 7, wherein the process step comprises a salicide process, an annealing process, a deposition process, a low dielectric material (low-K) treatment or an ultra-violet curing process.

11. The fabrication process of claim 10, wherein when the process step comprises the salicide process, the wafer is removed from the reaction chamber subsequent to the process step and prior to the surface treatment step.

12. The fabrication process of claim 7, wherein the thermal process apparatus is a rapid thermal process apparatus.

13. A thermal process apparatus, adoptable in a semiconductor process, the apparatus comprising:
a transparent device, disposed in a reaction chamber of the device;
a wafer holder for holding a wafer, wherein the wafer holder is disposed under the transparent device;
an energy source output device, disposed above the transparent device; and
a surface cleaning device, disposed in a reaction chamber for cleaning a surface of the transparent device.

14. The thermal process apparatus of claim 13, wherein the surface cleaning device is disposed between the transparent device the wafer holder, or underneath the wafer holder.

15. The thermal process apparatus of claim 13, wherein the surface cleaning device removes a coating material of the surface of the transparent device or alters the coating material to become transparent.

16. The thermal process apparatus of claim 13, wherein the surface cleaning device concurrently cleans the wafer holder.

17. The thermal process apparatus of claim 13, wherein the semiconductor process comprises a salicide process, an annealing process, a deposition process, a low dielectric material (low-K) treatment process or an ultra-violet curing process.

18. The thermal process apparatus of claim 13, wherein the thermal process apparatus is a rapid thermal process apparatus.

19. The thermal process apparatus of claim 13 further comprises a real-time monitoring system, disposed in the reaction chamber to continuously monitor a transparency of the transparent device.

20. The thermal process apparatus of claim 19 further comprises an advance process control (APC) device to automatically feedback detection results to the surface cleaning device.
